(19) United States
(12) Patent Application Publication
(10) Pub. No.: US 2005/0276159 A1
(43) Pub. Date: Dec. 15, 2005

(54) Method for transporting polymer dispersions

(76) Inventors: Walter Kastenhuber, Mannheim (DE); Hubertus Kroner, Neustadt (DE); Steffen Funkhauser, Viernheim (DE)

Correspondence Address: NOVAK DRUCE DELUCA & QUIGG, LLP, 1300 EYE STREET NW, SUITE 400 EAST, WASHINGTON, DC, 20005, US

(21) Appl. No.: 11/205,068

(22) Filed: Aug. 17, 2005

Related U.S. Application Data
(62) Division of application No. 10/069,366, filed on Feb. 25, 2002.

(30) Foreign Application Priority Data
Aug. 25, 1999 (DE) 19940399.6

(51) Int. Cl. B01F 5/10

(52) U.S. Cl. 366/265

(57) ABSTRACT

The invention relates to an apparatus for transporting polymer dispersions, said apparatus being capable of being driven by a drive and being designed as an impeller (28). It is possible for said impeller both to be surrounded by a housing and to protrude freely into the polymer dispersion contained in the reactor tank. A number of vanes (2) are mounted in the region of the hub (1) of the impeller (28) in such a way that pumping spaces (5, 25) on the front side (7) and rear side (8) of the impeller (28) are flowed through uniformly.

The invention relates to an apparatus for transporting polymer dispersions, such as for example shear-sensitive polymer dispersions, to be prepared in a stirred-tank reactor.

To avoid the heating up of reactors, such as for example stirred-tank reactors, in which polymer dispersions are prepared, they are assigned external heat exchangers. The polymer dispersion is fed to these in order to dissipate the heat of reaction occurring. For this purpose, the reaction mixture—the polymer dispersion being created—is pumped out of the reactor with a constant mass flow by the heat exchanger. After extracting the heat of reaction, the reaction mixture is returned to the stirred-tank reactor.

The polymer dispersions to be prepared may be very shear-sensitive and may change their viscosity within wide ranges during the preparation process. The polymer dispersions may tend to coagulate and assume a foam-like product consistency, as a result of which the pump circulating the reaction mixture has to meet special requirements. The pump should transport with as little shearing as possible, so that coagulation is prevented, and the pump should be insensitive to gas components in the product to be transported. Furthermore, the pump should be insensitive to a certain amount of deposit formation.

In the transporting of polymer dispersions, as are known under the names Acronal 2010 B, 311 S and Diofan 290 D, so far pumps in which the impellers tend to block after the beginning of polymerization have been used. This was caused by the formation of polymerisate in regions of the impeller where there is a poor through-flow and where deposits have formed, for example on stiffening and reinforcing ribs, then leading to failure of the pumps within a very short time. In the case of previously used configurations, it was unimportant whether the impellers were enclosed by a spiral housing or protruded freely from the pumping space.

On the basis of the prior art outlined, it is an object of the present invention to avoid to the greatest extent the adhering of polymer dispersions to these transporting apparatuses.

This object is achieved according to the invention in the case of an apparatus for transporting polymer dispersions, where it is possible for the apparatus to be driven by a drive and for the impellers of the apparatus to be surrounded by a housing, by a number of vanes being freely mounted in the region of the hub of the impellers in such a way that the pumping spaces on the front side and rear side of the impeller are flowed through uniformly.

The advantage of this solution is that, for low-viscosity, high-viscosity and semi-liquid polymer dispersions, there are no longer any dead spaces at the impellers where the constituents of the dispersions can be deposited in the form of layers one on top of the other. With the solution according to the invention, a relative velocity between the medium and the vane can be retained in the pumping spaces on both sides of the curved vane, so that a relative movement between the medium and the adjacent vanes and the impeller hub is ensured at all times while the medium is in the pumping space.

In a further refinement of the idea underlying the invention, the angle of entry for the medium into the pumping spaces or the impeller pockets of the impeller is between 30° and 120°, preferably 90° at the entry hub. This ensures a uniform inflow of the medium, such as for example a shear-sensitive polymer dispersion. Between six and twelve individual vanes may be mounted on the hub of the impeller, the number of vanes being dependent on the overall diameter of the impeller, the viscosity of the shear-sensitive products to be transported and the rotational speed of the drive. For reasons of optimum efficiency of the impeller according to the invention, eight vanes are mounted on the circumference of the hub.

To reduce the shear occurring, and to avoid the formation of deposits and permit improved cleaning of the impeller, the entire impeller may preferably be provided with a conductive PFA coating.

The vanes bounding the pumping spaces of the impeller have the same curvature on their front side, the delivery side, and on their rear side, the suction side. Thus, the front side and rear side may have the same radius of curvature, with the edges of all the vanes being of a well-rounded design in order not to hinder the flow movement of the shear-sensitive polymer dispersions around the individual vanes and in the region of the shaft hub.

In a design variant, the curvature of the center lines of the individual vanes between the center of the hub and the outer enveloping curve may describe a segment of a circle, which allows easier production of the vane geometry. The cross-sectional area of the individual vanes connected to the hub of the impeller is dimensioned in such a way that the areas bounding the pumping space on the delivery and suction sides of the vanes are wider than the material thickness of the vanes. For strength reasons, the material thickness must not be less than a certain value, it also being necessary for the design of the impeller with respect to mechanical strength to take into consideration the rotational speed and the media to be transported by the impeller according to the invention.

If an impeller according to the invention is arranged centrally in a spiral housing surrounding it, the desired transporting rates can advantageously be achieved already at relatively low drive speeds, the material stress occurring being relatively low in comparison with stresses occurring at higher speeds, which considerably increases the service life of the impeller.

The impeller according to the invention allows transporting from a stirred-tank reactor into a heat exchanger for extracting the exothermic heat of reaction that avoids the coagulation of shear-sensitive polymer dispersions and can be provided particularly advantageously in the associated circulating system. The impeller itself may both protrude freely into the pumping space and be enclosed by a housing, depending on the intended application.

The invention is explained in more detail below with reference to the drawing, in which:

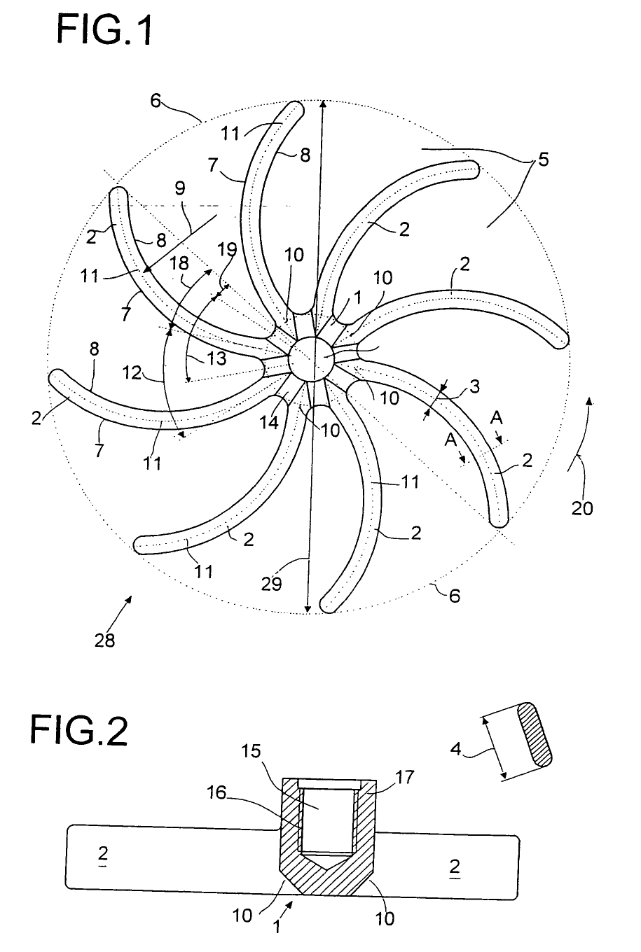

FIG. 1 shows the plan view of an impeller of a relatively large diameter,

FIG. 2 shows a section through the shaft hub of the impeller according to FIG. 1,

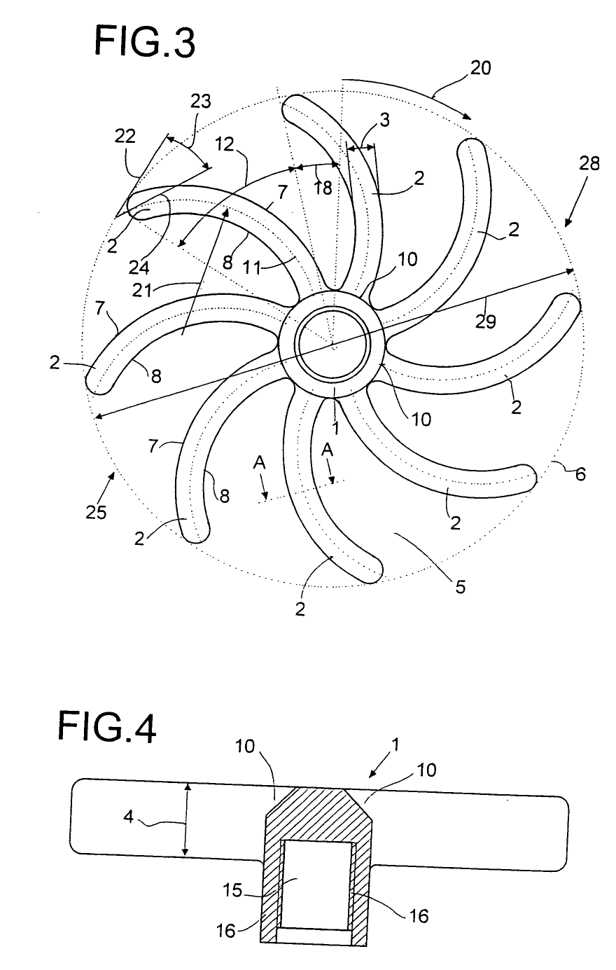

FIG. 3 shows the view of the drive side of an impeller with a relatively small diameter,

FIG. 4 shows the section through the impeller according to FIG. 3 and

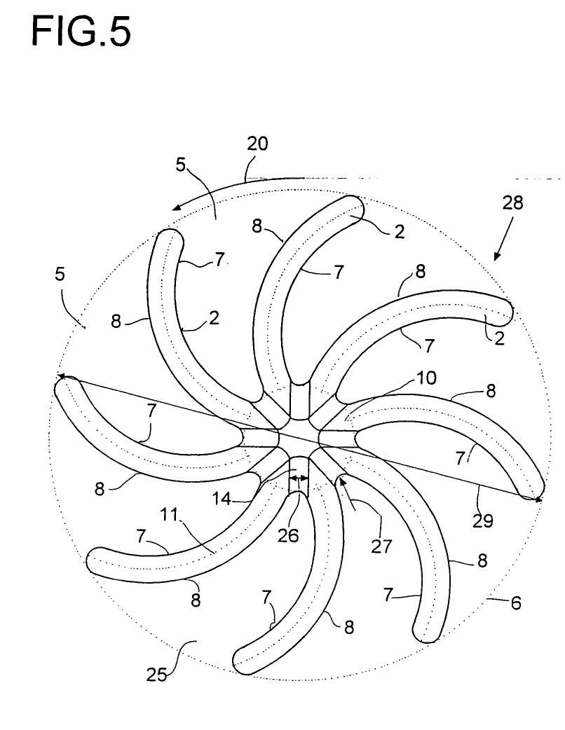

FIG. 5 shows the plan view of the impeller according to FIG. 3.

In the representation according to FIG. 1, the plan view of an impeller of a relatively large diameter is reproduced.

The impeller 28 is fastened at its shaft hub 1 onto a drive shaft of a drive and has a number of vanes 2, which are all fastened to the hub 1. The individual vanes 2 are of a relatively large vane width 4 in comparison with their material thickness 3 and have a substantially rectangular cross-sectional profile. Formed between the individual vanes 2 are pumping spaces 5, which are bounded by a respective vane front side 7 and a vane rear side 8. The vane front side 7 represents the delivery side, while the vane rear side 8 represents the suction side of the runner at the impeller 28. The individual vanes 2 are formed in a vane curvature 9, which extends from the respective vane root 10 along the center line 11 of the vanes 2 to the enveloping curve 6, which encloses the ends of all the vanes 2 of the impeller 28.

With respect to the tangents to the center lines 11 in the region of the vane roots 10 of the vanes 2, the individual vanes 2 are arranged in relation to one another by the pitch angle 12. The free spaces 14 formed between two vane roots 10 are arranged offset in relation to one another by the pitch angle 13, with the pitch angle 12 for the vanes 2 and the pitch angle 13 for the free spaces 14 both being 45° when there are eight vanes 2 on the impeller 28. The vanes 2 may, for example, describe with their center line 11 a segment of a circle between the enveloping curve 6 and the center of the hub 1, as indicated in FIG. 1. This vane geometry can be produced favorably in terms of production engineering.

The vanes 2 each have a front side 7 and a rear side 8, the front side 7 and the rear side 8 having identical paths of curvature. The free arrangement of the vanes 2 around the hub 1 has the effect that no dead spaces occur in the pumping spaces, so that a relative movement between the polymer dispersion and the impeller 28 is ensured at all times. Since relative movements occur between the medium and the contact areas on the impeller 28 at all times and at every location during the flowing through of the pumping spaces 5, only minimal deposits of polymerized through material are able to form on the impeller 28 and on the housing surrounding it.

As a result of the direction of rotation 20 of the impeller 28, the respective delivery side of the runner is formed on the front side 7 of the vanes 2, while the suction side, replenished by new medium to be transported, is formed on the rear side 8 of the vanes 2. The vanes 2 are in each case of a well-rounded form in the region of their edges, so that a flow with as little shearing as possible is established around the individual vanes 2 on the impeller 28. The length and path of curvature of the individual vanes 2 determine the diameter 29 of the impeller 28, the length of the vanes 2 being dimensioned such that they have adequate strength properties even in their end regions near the enveloping curve 6.

FIG. 2 shows the section through an impeller 28, the section being taken through the shaft hub 1. A thread 16 is provided there at a blind hole 15. The thread 16 is of such a nature that the sense of rotation of the thread 16 is directed counter to the direction of rotation of the impeller 28; the impeller 28 is unable to come loose during its rotation in the direction of rotation 20 during operation, but instead is constantly tightened. From the view according to FIG. 2 there can also be seen the vane roots 10, at which the vanes 2 are connected to the hub 1, on which the hub continuation 17 extends on the drive side of the hub 1. Provided in the region of the vane roots 10 are bevels of approximately 45°, in order to avoid deposits occurring there on the vane roots 10 of the impeller 28 in the case of shear-sensitive materials.

FIG. 3 shows an impeller 28, which is formed with a relatively small diameter 29, but even so receives eight vanes 2 on the hub 1, which however are curved to a greater extent in comparison with the configuration according to FIG. 1.

The ends of the vanes 2 lie within the enveloping curve 6; their respective center line 11 is formed with a radius of curvature 21 which is less than the radius of curvature 9 represented in FIG. 1. The front side 7, the delivery side, and the rear side 8, the suction side, are formed with an identical path of curvature and between them form the respective pumping spaces 5. At the ends of the vanes 2 there lies between the tangent 22 to the enveloping curve 6 and the tangent 24 to the center line 11 of the vane 2 the exit angle 23, at which the shear-sensitive polymer dispersion leaves the respective pumping space 5. The pitch angle 12 at which the vanes 2 are arranged on the circumference of the hub 1 is also 45° in the exemplary embodiment represented in FIG. 3. The angular offset 18 marks the distance between the perpendicular intersecting the enveloping curve 6 from the end of the vane 2 through the center of the hub 1 and the rear side 8 of the vane 2. It is also the case in the configuration shown in FIG. 3 that the material thickness 3 of the vanes 2 is less than the vane width 4 of the vanes, which increases the pump efficiency.

FIG. 4 shows a section through the shaft hub 1 of the impeller 28 according to FIG. 3. The edges of the vanes 2, of a well-rounded form in analogy with FIG. 1, make it possible for the medium to be transported to flow around the vanes 2 without deposits and the formation of layers of polymerized-through material occurring in the contact region due to the formation of dead spaces. Here, too, in the hub continuation 17 there is formed a blind hole 15, in which a thread 16 is provided. In analogy with the configuration already described above, the connection between the drive shaft of the drive motor or gear mechanism and the impeller 28 takes place here.

FIG. 5 shows the plan view of the impeller 28 according to FIG. 3, which rotates in direction of rotation 20.

The pumping spaces 5 or impeller pockets 25 are bounded by the curved front sides 7, the delivery sides, and the curved rear sides 8, the suction sides, of the vanes 2. In the region of the vane root 10 (cf. FIGS. 2, 4), the vanes 2 are provided with bevels, which run at an angle of approximately 45°, in order to achieve as uniform a flow as possible around the hub region of the impeller 28. Formed above the free spaces 14, which are provided between the vane roots 10 of the individual vanes 2, are radii of curvature 27, which lie centrally in relation to the width 26 of the free space 14. The mutually adjacent free spaces 14 create in the region of the hub a star-shaped flow region, which makes it possible for the shear-sensitive polymer dispersion to flow through without the build-up of coagulated polymer material occurring.

The impeller 28 may be produced from metal, particular attention having to be paid to deburring of the contact regions of the individual vanes 2. In addition to production from one piece, the individual vanes 2 may also be fastened in the region of the hub 2 on the outer circumference of the latter, for instance by means of a thermal joining process, before a coating of the outer surfaces takes place with a conductive material, such as PFA for example.

### List of Reference Numerals

1 shaft hub
2 vane
3 vane thickness
4 vane width
5 pumping space
6 enveloping curve
7 vane front side
8 vane rear side
9 vane curvature
10 vane root
11 vane center line
12 pitch angle of vanes
13 pitch angle of free spaces
14 free space
15 blind hole
16 thread
17 hub continuation
18 angular offset of vane
19 angular offset of free space
20 direction of rotation
21 radius of curvature
22 tangent to enveloping curve
23 exit angle
24 tangent
25 impeller pocket
26 width of free space
27 radius of curvature of free space
28 impeller
29 diameter of impeller

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method for transporting a polymer dispersion, comprising using an apparatus with an impeller, surrounded by a housing or protruding freely into the polymer dispersion, said impeller having a shaft hub and a number of individual curved vanes freely mounted on the shaft hub, to create pumping spaces on the front side and rear side of the curved vanes of the impeller, wherein the pumping spaces are so formed as to move the polymer dispersion through the pumping spaces with a uniform flow.

15. The method as claimed in claim 1, wherein the angle of entry into the pumping spaces lies between 30° and 120°.

16. The method as claimed in claim 2, wherein the angle of entry into the pumping spaces is 90°.

17. The method as claimed in claim 1, wherein the entire impeller is provide with a conductive PFA coating.

18. The method as claimed in claim 1, wherein the curved vanes bounding the pumping spaces have the same path of curvature on the front side and rear side.

19. The method as claimed in claim 5, wherein the curved vanes have the same radius of curvature on the front side and rear side.

20. The method as claimed in claim 1, wherein the center line of the curved vanes on the impeller describe a segment of a circle between the enveloping curve and the center of the hub.

21. The method as claimed in claim 1, wherein the edges of the curved vanes of the impeller are of a rounded form.

22. The method as claimed in claim 1, wherein the ratio of the vane width to the vane thickness is >1.

23. The method as claimed in claim 1, wherein the enveloping curve of the impeller is surrounded by a spiral housing.

24. A method for transporting a polymer dispersion, comprising using an impeller with a shaft hub and a number of individual curved vanes freely mounted on the shaft hub of the impeller to create pumping spaces on the front side and rear side of the curved vanes of the impeller, the pumping spaces moving the polymer dispersion through the pumping spaces with a uniform flow, the impeller being driven by a drive, and the entire impeller being provided with a conductive PFA coating.

25. A method of preparing polymer dispersions, in particular shear sensitive polymer dispersions, in a reactor with an external heat exchanger, with a transporting device which receives an impeller wherein the polymer dispersion flows through pumping spaces between the curved vanes of the of the impeller of which delivery and suction sides are of the same geometry.
